(19) United States
(12) Patent Application Publication
(10) Pub. No.: US 2004/0071196 A1
(43) Pub. Date: Apr. 15, 2004

(54) Method and apparatus for code phase correlation

(75) Inventors: Ian A. Marsden, Redhill (GB); Andrew T. Yule, East Grinstead (GB)

Correspondence Address: PHILIPS INTELLECTUAL PROPERTY & STANDARDS, P.O. BOX 3001, BRIARCLIFF MANOR, NY, 10510, US

(73) Assignee: U.S. Philips Corporation

(21) Appl. No.: 09/726,760

(22) Filed: Nov. 30, 2000

(30) Foreign Application Priority Data
Jan. 12, 1999 (GB) 9928356.6

(51) Int. Cl. H04K 1/00

(52) U.S. Cl. 375/147; 342/357.12

(57) ABSTRACT

A method of code phase correlation and apparatus (10 to 15) implementing the same is disclosed, the method comprising the steps of (a) receiving a subject signal comprising a target pseudorandom noise code; (b) generating early and late replica code signals corresponding to the target code; (c) correlating the subject signal with the early and late replica code signals and returning respective early and late correlation values; and (d) calculating a code phase discriminator for determining whether the target code has been acquired as a function of the sum of the early and late correlation values.

This invention relates to a method of code phase correlation for code division multiple access (CDMA) type communication and also to apparatus incorporating means for the same.

The invention is of particular benefit to the field of global positioning systems (GPS) and is described with reference to GPS hereafter, however, such reference should not be interpreted as limiting the scope of the invention to merely GPS. Also, at present, GPS is most notably associated with the Navigation System with Time and Ranging (NAVSTAR) GPS, an all weather, spaced based navigation system developed and operated by the US Department of Defense, although the general principles underlying GPS are universal and not merely limited to NAVSTAR. Accordingly, GPS hereafter refers to any global positioning system comprising a plurality of CDMA radio transmitters at different locations and a receiver which determines its location based on the time of arrival of the transmissions of the radio transmitters.

The general principles underlying GPS and methods and apparatus for its implementation are known. For example, see GPS Principles and Applications (Editor, Kaplan) ISBN 0-89006-793-7 Artech House, hereinafter “Kaplan”.

GPS receivers generally comprise a pseudorandom noise (PRN) code tracking loop in which early (E), prompt (P) and late (L) replica codes of satellite PRN codes are continuously generated, and compared to the incoming satellite PRN codes as received by the receiver. A code phase discriminator is calculated as a function of the correlation between the replica and incoming codes in order to determine whether the incoming code has been acquired such that if the code phase discriminator exceeds a predetermined threshold level, the incoming PRN code and the locally generated replica are assumed to be in phase, i.e. code acquisition. If not, the code generator produces the next series of replicas with a phase shift, typically of one chip, and the code phase discriminator is recalculated.

A selection of known code phase discriminators shown in table 1 below.

TABLE 1
Conventional Code Phase Discriminators

| Code Phase Discriminator | Algorithm |
|---|---|
| Dot product power | $\sum ( {I}_{E} - {I}_{L} ) {I}_{P} + \sum ( {Q}_{E} - {Q}_{L} ) {Q}_{P}$ |
| Early minus late power | $\sum ( {I}_{E}^{2} + {Q}_{E}^{2} ) - \sum ( {I}_{L}^{2} - {Q}_{L}^{2} )$ |
| Early minus late envelope | $\sum \sqrt{( {I}_{E}^{2} + {Q}_{E}^{2} )} - \sum \sqrt{( {I}_{L}^{2} - {Q}_{L}^{2} )}$ |
| Normalized early minus late envelope | $\frac{\sum \sqrt{( {I}_{E}^{2} + {Q}_{E}^{2} )} - \sum \sqrt{( {I}_{L}^{2} - {Q}_{L}^{2} )}}{\sum \sqrt{( {I}_{E}^{2} + {Q}_{E}^{2} )} + \sum \sqrt{( {I}_{L}^{2} - {Q}_{L}^{2} )}}$ |

Assuming carrier phase lock, a linear code sweep should eventually result in the incoming PRN code being in phase with that of the locally generated replica and therefore, if detected, code acquisition.

In order the acquire the code signal more quickly, it is desirable to increase the rate at when the replica code is swept, however, the effect of this is to reduce the magnitude of the discriminator. If the discriminator threshold is set too low, a false alarm may occur due to noise whereby code acquisition is incorrectly flagged. This is costly in terms of time lost when either the code phase is re-checked or the receiver attempts to track the signal. Also if the correct phase is missed by the threshold being set too high, the complete search process will need to be repeated to locate the correct phase.

It is therefore an object of the invention to provide a method of code phase correlation with enhanced code phase discrimination and apparatus incorporating the same.

Accordingly, a method of code phase correlation is provided comprising the steps of (a) receiving a subject signal containing a target pseudorandom noise code; (b) generating early and late replica code signals corresponding to the target code; (c) correlating the subject signal with the early and late replica code signals and returning respective early and late correlation values; and (d) calculating a code phase discriminator for determining whether the target code has been acquired as a function of the sum of the early and late correlation values.

Such a method reduces the average time taken for code phase acquisition over a range of signal to noise ratios (SNRs) and chip advance rates.

Where the subject signal is received as a carrier wave signal modulated by the target code, the method may further comprise the step of providing in phase (I) and quadrature phase (Q) components of subject signal; wherein, the I and Q components are each correlated with the early (E) and late (L) replica code signals to provide respective I_{E}, I_{L}, Q_{E} and Q_{L} correlation values; and wherein the code phase discriminator is calculated as a function of either I_{E}+I_{L} or Q_{E}+Q_{L}.

This provides enhanced code phase correlation in circumstances where there is no precise carrier phase lock.

Ideally, the code phase discriminator (CPD) is calculated according to either equation 1 or equation 2:

CPD=(I_{E}+I_{L})+(Q_{E}+Q_{L})² [Equation 1]

CPD=Σ(I_{E}+I_{L})²+Σ(Q_{E}+Q_{L}) [Equation 2]

wherein, in equation 2, summation occurs over substantially the whole of the target code.

Further provided is apparatus comprising signal processing means adapted to implement a method of code phase correlation according to the present invention.

Yet further provided is a GPS receiver comprising receiver means for receiving a subject signal containing a target pseudorandom noise code; and processing means for generating early and late replica code signals corresponding to the target code, correlating the subject signal with the early and late replica code signals and returning respective early and late correlation values, and calculating a code phase discriminator for determining whether the target code has been acquired as a function of the sum of the early and late correlation values.

In circumstances where there is no precise carrier phase lock and the GPS receiver receives the subject signal as a carrier wave signal modulated by the target code, it is preferable that in phase (I) and quadrature phase (Q) components of subject signal are provided wherein the I and Q components are each correlated with the early (E) and late (L) replica code signals to provide respective I_{E}, I_{L}, Q_{E} and Q_{L} correlation values; and wherein the code phase discriminator is calculated as a function of either I_{E}+I_{L} or Q_{E}+Q_{L}.

Ideally, the code phase discriminator (CPD) is calculated according to either equation 1 or equation 2 wherein, in equation 2, summation occurs over substantially the whole of the target code.

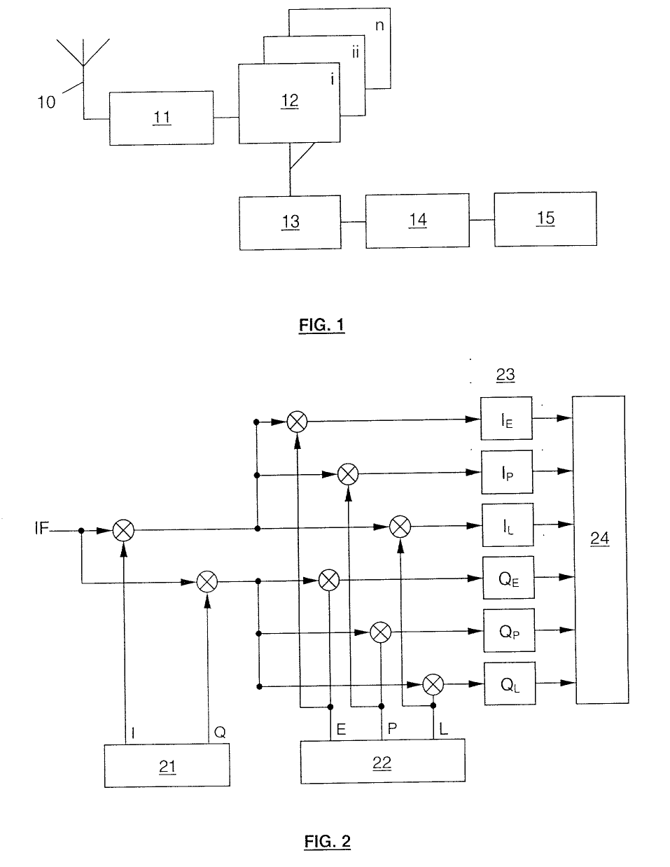

A GPS receiver using a method in accordance with the present invention will now be described, by way of example only, with reference to FIGS. 1 and 8 in which:

FIG. 1 shows, schematically, a GPS receiver according to the present invention;

FIG. 2 shows, schematically, the receiver channels and receiver processor of the GPS receiver of FIG. 1 in greater detail;

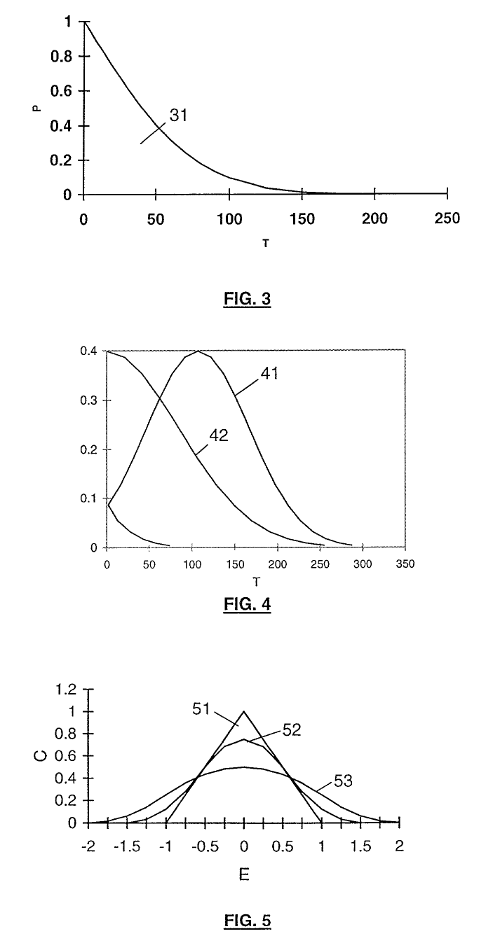

FIG. 3 is a graph showing the relationship between the probability of a false alarm and the correlation threshold level;

FIG. 4 is a graph showing a normalised, noise and signal distribution at 2 dB;

FIG. 5 is a graph showing the relationship between the correlation output and code phase error;

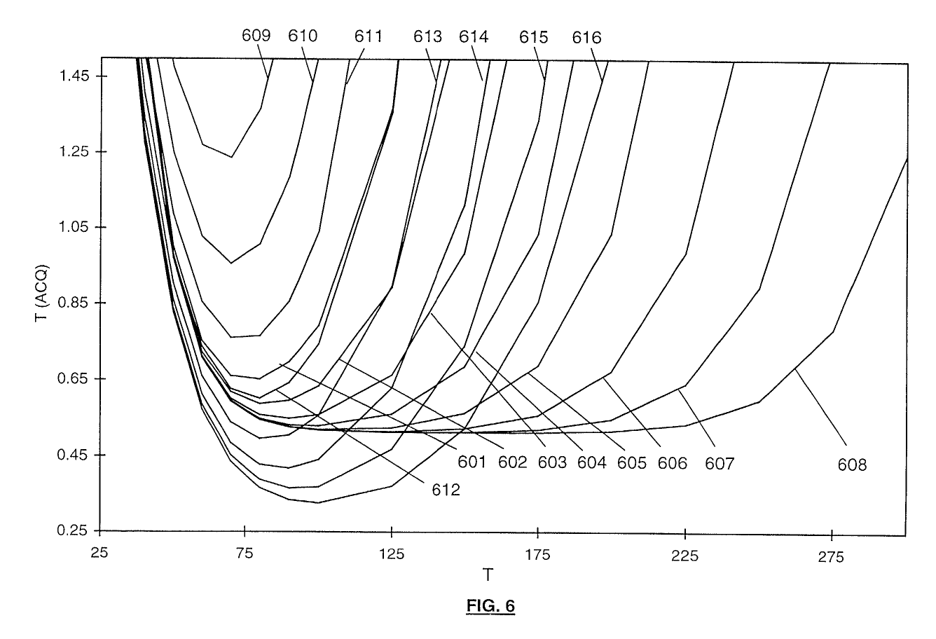

FIG. 6 is a graph showing, in a conventional receiver, the relationship between the signal acquisition time and the correlation threshold, for a range of SNRs using both single and double chip advance rates; and

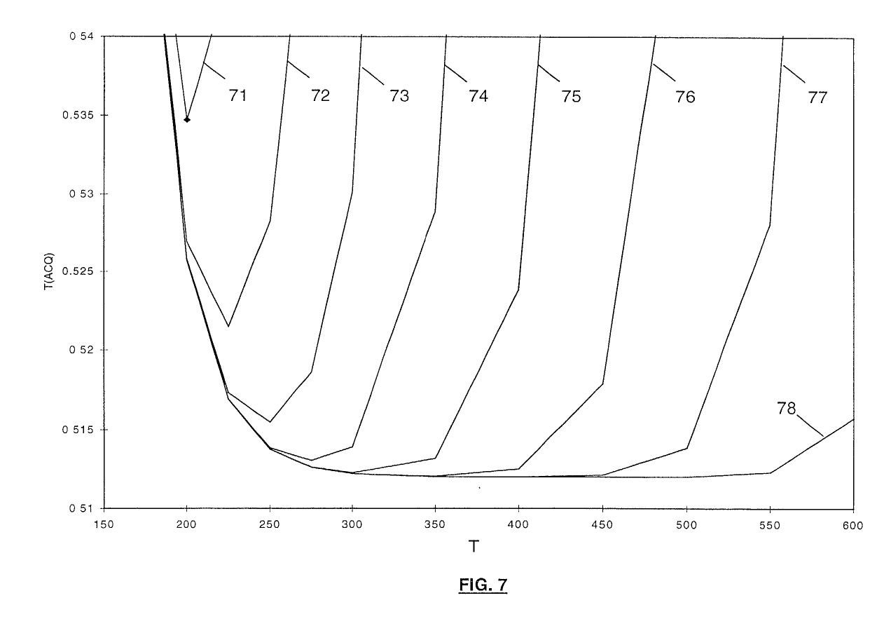

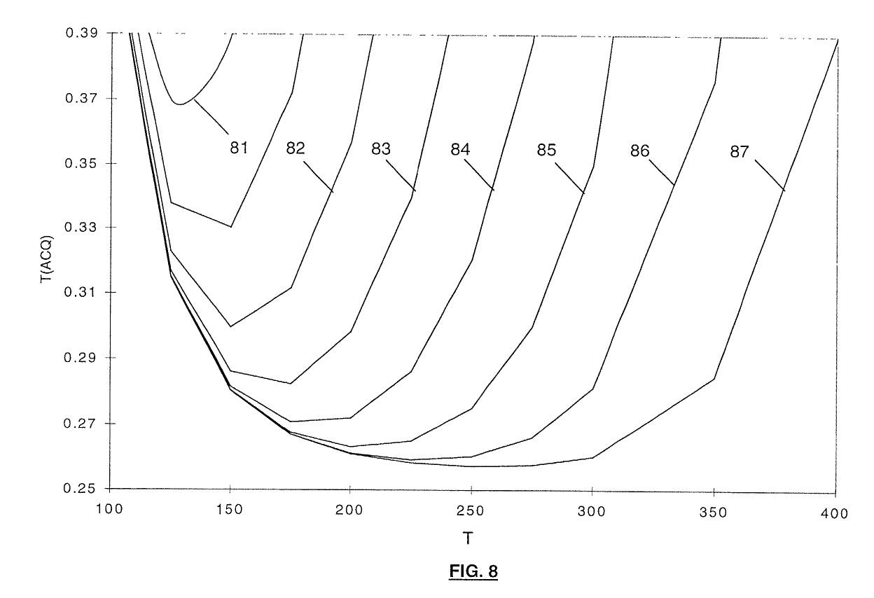

FIGS. 7 and 8 are graphs showing, in the receiver of FIG. 1 and according to the present invention, the relationship between the signal acquisition time and the correlation threshold, for a range of SNRs using single and double chip advance rates respectively.

As is well known, each NAVSTAR GPS satellite transmits two carrier frequencies; L1, the primary frequency at 1575.42 MHz and L2, the secondary frequency at 1227.60 MHz. The carrier frequencies are modulated by spread spectrum codes with a PRN sequence unique to each satellite and also by the navigation data message. The L1 signal is modulated by both the course/acquisition (C/A) code and the precision (P[Y]) code whereas the L2 signal is modulated by the P[Y] code only. The P[Y] codes relate to the precise positioning service (PPS) primarily for military and select government agency users whereas the C/A relates to the standard positioning service (SPS) for which there is currently unrestricted access.

FIG. 1 shows, schematically, the architecture of a GPS receiver according to the present invention. SPS GPS signals are received by an antenna 10 and pre-processed in a pre-processor 11; typically by passive bandpass filtering in order to minimise out-of-band RF interference, preamplification, down converting to an intermediate frequency (IF) and analog to digital conversion. The resultant, digitised IF signal remains modulated, still containing all the information from the available satellites, and is fed into each of twelve parallel receiver channels 12 (one such channel is shown in FIG. 2). The satellite signals are acquired and tracked in respective digital receiver channels in co-operation with the receiver processor 13 for the purpose of acquiring navigation information. Such methods for acquisition and tracking are well known, for example, see chapter 4 (GPS satellite signal characteristics) & chapter 5 (GPS satellite signal acquisition and tracking), Kaplan ibid.

Using acquired navigation information and the time of arrival of the transmissions, the navigation processor 14 calculates the position of the receiver using conventional algorithms and that position is displayed on a display 15 to the user.

The pre-processor 11 will be typically implemented in the form of front end analogue circuitry with the digital receiver channels 12, the receiver processor 13 and the navigation processor 14 implemented in the form of a general purpose microprocessor or a microprocessor embedded in a GPS application specific integrated circuit (ASIC).

FIG. 2 shows, schematically, the receiver channel co-operating with the receiver processor in greater detail. In order to retrieve the information on the incoming signal, a carrier wave (CW) must be removed and this is done by the receiver generating in-phase (I) and quadrature phase (Q) replica carrier wave signals using a carrier wave generator 21. The replica carrier waves ideally have the same frequency as the received signal, however, due to Doppler shift caused by the relative movement between the receiver and orbiting satellites, the frequency of the GPS signals as received in the receiver normally differs from the precise satellite transmission frequency. In order to accurately replicate the frequency of the received carrier wave, a conventional carrier wave phase lock loop (PLL) may be employed. It is possible, though undesirable, to omit the carrier phase lock stage altogether as the Doppler shift of the carrier and its associated effect on the code phase discriminator are reasonably small.

In order to acquire code phase lock, early (E), prompt (P) and late (L) replica codes of the PRN sequences are continuously generated by a code generator 22 at a frequency related to the received carrier (i.e. plus Doppler). The replica codes are then correlated with the I and Q signals to produce three in-phase correlation components (I_{E}, I_{L}, I_{P}) and three quadrature phase correlation components (Q_{E}, Q_{L}, Q_{P}), typically by integration in an integrator 23 over substantially the whole of the PRN code. In the receiver processor 13, a code phase discriminator is calculated as a function of the correlation components in accordance with equation 3, below:

CPD=Σ(I_{E}+I_{L})²+Σ(Q_{E}+Q_{L})² [Equation 3]

A threshold test is applied to the code phase discriminator and a phase match declared if the code phase discriminator is high. If not, the code generator produces the next series of replicas with single chip phase advance and the code phase discriminator is recalculated. Any declared phase match is validated by recalculating the discriminator. A linear phase sweep will eventually result in the incoming PRN code being in phase with that of the locally generated replica and thus code acquisition.

Without wishing to be bound by any theory, the inventors believe the effectiveness of a method of code phase correlation according to the present invention (i.e. reduced time taken for code phase acquisition) can be attributed to the behaviour of noise. The I and Q signal components are swamped by a large amount of thermal noise and although integration during the correlation process removes most of it, it does not remove it all. To illustrate the magnitude of the noise problem, if the IF signal is sampled at 4.8 MHz, the theoretical maximum, noise free, cumulative correlation output obtainable when comparing a subject PRN code with a replica is 4800. In practice, however, the maximum correlation output is only about 600 due to noise degradation.

Both signal and noise distributions can be likened to a normal distribution with a finite mean and variance and when two normal distributions are combined, the resultant distribution has the following mean and variance:

Combined Mean=\overline{x}+\overline{y} [Equation 4]

Combined Variance=sₓ²+s₂² [Equation 5]

As such, the combination of two noise distributions, each having a mean of zero, results in a combined noise distribution with a mean of zero whereas the combination of two non-zero signal distributions results in a signal distribution of increased mean. Therefore, the combination of the early and late correlation values results in a correlation signal of increased magnitude relative to noise. However, as the variances of both the signal and noise distributions also increase, it is useful to consider whether summing the early and late correlation values actually improves the signal acquisition time, preferably over a range of SNRs and chip advance rates.

To be able to calculate the average acquisition time (T_{acq}) for different chip advance rates and SNRs, the following equation may be used:

$${T}_{acq} = ( C - 1 ) {T}_{da} ( \frac{2 - {P}_{d}}{2 {P}_{d}} ) + \frac{{T}_{i}}{{P}_{d}} \qquad [ Equation 6 ]$$

where C is the number of possible code phases to be checked, Tᵢ is the time taken to check a single code phase, T_{da} is the average dwell time at a code phase and P_{d} is the probability of detecting the signal when it is present. Equation 6 is derived and further described by R E Zeimer, Digital Communications and Spread Spectrum Systems, Macmillan, 1985, ISBN 0-02-431670-9.

For a single chip advance rate, the value of C is 1023 corresponding to the C/A code length although for a double chip advance rate, it is halved to 511.5. The time taken to check a single code phase is assumed to be constant at 1 ms, the single chip transmission period.

The average dwell time is the average time duration that is used up at any code phase confirming that it is or is not the correct phase. In particular, the value relates to the number of correlator rechecks that are executed before signal tracking commences. By executing re-checks the chance of a false alarm is greatly reduced and this is beneficial as the time wasted carrying out a recheck is significantly less than the time wasted attempting to track a non-existent satellite. Also, the threshold level can be reduced thereby allowing weaker signals to be detected.

As basis for calculating the average dwell duration, the following equation may be used:

T_{da}=Tᵢ+P_{fa}T_{fa} [Equation 7]

where P_{fa} is the probability of a false alarm and T_{fa} is the time taken to deal with a false alarm.

Where no re-check system is operative, i.e. the correlation threshold need only be exceed once before signal tracking commences, there are two possibilities, either a single false alarm occurs or it does not occur. Assuming the system identifies a lack of signal lock (i.e. a false alarm) after approximately 25 ms, if a false alarm does not occur, the dwell time is 1 ms. If one does occur, the dwell time is 26 ms. Therefore:

T_{da}=(1−P_{fa})×1 ms+P_{fa}×26 ms [symbol] T_{da}=(1+25P_{fa})ms [Equation 8]

or

T_{da}=z⁻¹(1+25P_{fa}) [Equation 9]

where z is the z-transform variable used to represent the standard 1 ms delay.

A similar analysis can be applied to single and multiple stage dwell systems and expressions derive for the average dwell times (T_{da}) as a function of the probability of a false alarm (P_{fa})

If the system is operating at a single chip advance rate, the late channel is merely following the early channel one chip later. In such a system, it is preferable that the late channel is used as a real-time threshold check, i.e. before the code phase scan is actually stopped and either re-checking or tracking commenced. Thus, by dwell, what is really meant is the quantity of threshold tests carried out and not the dwell number (the number of recheck cycles) carried out by the system. Thus, a single chip advance system with one dwell period and two correlator checks is directly comparable to the double chip advance technique which has two dwell periods and two correlator checks. This effects only the maths in the fact that P_{fa} in equation 7 becomes P_{fa}².

A summary of the average dwell times expressed in terms of the probability of a false alarm is provided in table 2 below:

TABLE 2
Average dwell time for single and multiple dwell systems

| No. of dwells | Single Chip Advance |
|---|---|
| 1 | n/a |
| 2 | T_{da} = z⁻¹(1 + 25P_{fa}²) |
| 3 | T_{da} = z⁻¹(1 + P_{fa}² + 25P_{fa}³) |
| 4 | T_{da} = z⁻¹(1 + P_{fa}² + P_{fa}³ + 25P_{fa}⁴) |
| 5 | T_{da} = z⁻¹(1 + P_{fa}² + P_{fa}³ + P_{fa}⁴ + 25P_{fa}⁵) |
| 6 | T_{da} = z⁻¹(1 + P_{fa}² + P_{fa}³ + P_{fa}⁴ + P_{fa}⁵ + 25P_{fa}⁶) |
| No. of dwells | Double Chip Advance |
| 1 | T_{da} = z⁻¹(1 + 25P_{fa}) |
| 2 | T_{da} = z⁻¹(1 + P_{fa} + 25P_{fa}²) |
| 3 | T_{da} = z⁻¹(1 + P_{fa} + P_{fa}² + 25P_{fa}³) |
| 4 | T_{da} = z⁻¹(1 + P_{fa} + P_{fa}² + P_{fa}³ + 25P_{fa}⁴) |
| 5 | T_{da} = z⁻¹(1 + P_{fa} + P_{fa}² + P_{fa}³ + P_{fa}⁴ + 25P_{fa}⁵) |
| 6 | T_{da} = z⁻¹(1 + P_{fa} + P_{fa}² + P_{fa}³ + P_{fa}⁴ + P_{fa}⁵ + 25P_{fa}⁶) |

The probability of a false alarm is related to the SNR of the signal and the correlation threshold level. The noise signal can be considered normally distribution with a mean value of zero and a standard deviation of approximately 60. However, as conventional apparatus does not differentiate between positive and negative noise, and the noise distribution is actually one sided and the effective standard deviation of the signal is approximately 84.85 (double the variances).

Curves 31 of FIG. 3 illustrates how the probability of a false alarm due to the noise signal varies according to the position of the threshold. It can be seen that the lower the threshold, the greater the chance of a false alarm occurring due to noise.

The probability of detection (Pd) is calculated as follows. The SNR of a signal can be expressed as a function of its mean and the variance of the noise:

$$SNR = 10 * {log}_{10} ( \frac{{SignalMean}^{2}}{Noise Variance} ) \qquad [ Equation 10 ]$$

As the noise variance is known, the signal means corresponding to a range of SNRs can be calculated, as shown in table 3 below:

TABLE 3
Relationship between SNRs and Signal Mean Values

| | Signal Mean |
|---|---|
| SNR | Value |
| 1 dB | 95.20 |
| 2 dB | 106.81 |
| 5 dB | 150.88 |
| 10 dB | 268.31 |
| 11 dB | 301.05 |
| 12 dB | 337.79 |
| 13 dB | 379.01 |
| 14 dB | 425.25 |
| 15 dB | 477.14 |
| 16 dB | 535.36 |
| 17 dB | 600.69 |
| 20 dB | 848.52 |
| 30 dB | 2683.19 |

By treating the signal as a normal distribution with mean value as above and distribution the same as the noise signal rather than a single peak, the probability of detection can be readily calculated, accommodating the one-sided nature of the distribution because of a system's inability to discriminate between positive and negative signal values. The signal distribution is distorted as FIG. 4 where curve 41 represents the signal and curve 42 presents the noise.

The probability of detection is further diminished by the effect of the code sweep. The PRN code generator produces an exact replica of the satellite PRN code over and over again, however each repeat is delayed by one chip. The one chip delay can be implemented by in a number of ways including scanning each cycle at the 1.023 MHz C/A code chipping rate and starting the next cycle one chip after the previous cycle has completed; or running the code generator either slightly faster or slower than the 1.023 MHz so as to either gain or slip one chip per code cycle respectively. Running the code generator either slightly faster or slower than the 1.23 MHz chipping rate still produces a correlator maximum at the correct phase but the peak is less pronounced. Curves 51, 52 and 53 of FIG. 5 shows the idealised correlator output as a function of code phase error with the code generator running at 1.023 MHz, one chip slower and two chips slower respectively.

For the purpose of this analysis, it is assumed that the single or double chip delay is obtained by varying the rate of the code generator accordingly. In the case of single chip advance system with the code generator running one chip per code cycle slower than the C/A chipping rate, and the early and late replica codes spaced one chip apart, if the code phase of the C/A code and replica match precisely, the early and late signals will each provide a 0.5 correlation, i.e. a total of 1.0. However, if the replica is 0.5 chip slower than the C/A code, the early and late signals will provide a 0.125 and 0.75 correlation respectively, i.e. a total of only 0.875.

The best and worst case scenarios for early, late and combined early and late correlation, for both single and double ship advance rates are listed in table 4 below.

TABLE 4
Best and worst case idealised correlation outputs for single and
double chip advance rates with and without combining early and late
channels.

| Advantage | | | | | |
|---|---|---|---|---|---|
| Strategy | Best or Worst case | Correlator output sequence | | | |
| Single Chip | Early Best | 0.5 | 0.5 | 0 | 0 |
| Advance | Late Best | 0 | 0.5 | 0.5 | 0 |
| | Combined Best | 0.5 | 1.0 | 0.5 | 0 |
| | Early Worst | 0.125 | 0.75 | 0.125 | 0 |
| | Late Worst | 0 | 0.125 | 0.75 | 0.125 |
| | Combined Worst | 0.125 | 0.875 | 0.875 | 0.125 |
| Double Chip | Early Best | 0.0625 | 0.4375 | 0 | 0 |
| Advance | Late Best | 0 | 0.4375 | 0.0625 | 0 |
| | Combined Best | 0.0625 | 0.875 | 0.0625 | 0 |
| | Early Worst | 0.4375 | 0.0625 | 0 | 0 |
| | Late Worst | 0.0625 | 0.4375 | 0 | 0 |
| | Combined Worst | 0.5 | 0.5 | 0 | 0 |

The probability of detection is evaluated for each best and worst cases for various SNRs and threshold values, and these values are then average, assuming linearity.

Having provided a basis for calculating the average dwell time (T_{da}) and the probability of detecting the signal when present (P_{d}), we can return to equation 6 to determine the average time for code signal acquisition for both conventional apparatus and apparatus according to the present invention, and for both single and double chip advance rates over a range of SNRs.

FIG. 6 shows how the signal acquisition time varies with the correlation threshold in conventional apparatus over a range of SNRs. The variation for SNRs of 10, 11, 12, 13, 14, 15, 16 and 17 dB is represented for single chip advance techniques by curves 601 to 608 respectively, and for double chip advance techniques by curves 609 to 616 respectively.

FIGS. 7 and 8 show how the signal acquisition time varies with the correlation threshold in apparatus according to the present invention. The variation for SNRs of 10, 11, 12, 13, 14, 15, 16 and 17 dB is represented for single chip advance techniques by curves 71 to 78 in FIG. 7 respectively, and for double chip advance techniques by curves 81 to 88 in FIG. 8 respectively.

Table 5 below summarises the average acquisition times using both single and double chip advances techniques and both with and without combining early and late channels for a high (10 dB) and low (17 dB) levels of noise.

TABLE 5
Average acquisition times with and without
combining early and late channels

| | Time/sec | Time/sec |
|---|---|---|
| Method | (for SNR of 10 dB) | (for SNR of 17 dB) |
| Single chip advance | 0.6412 | 0.5121 |
| Single chip advance | 0.5347 | 0.5120 |
| with combined early and | | |
| late channel | | |
| Double chip advance | 1.2368 | 0.3255 |
| Double chip advance | 0.3697 | 0.2574 |
| with combined early and | | |
| late channel | | |

It is evident that combining early and late correlation channels reduces the average time for signal acquisition, e.g. a reduction of 16% for a single chip advance technique at 10 dB and 21% for a double chip advance rate at 17 dB.

In the GPS receiver of the type shown schematically in FIGS. 1 and 2, as previously stated, the pre-processing, receiver channel and receiver processor will be typically implemented in the form of front end analogue circuitry combined with either a general purpose microprocessor or a microprocessor embedded in a GPS application specific integrated circuit. Implementation of a method of code phase correlation according to the present invention, including the example as described below, may be accomplished by appropriate analogue circuitry design and/or microprocessor programming. Of course, such design and programming is well known and would be accomplished by one of ordinary skill in the art of GPS and CDMA communication without due burden.

1. A method of code phase correlation comprising the steps of:
(a) receiving a subject signal containing a target pseudorandom noise code;
b) generating early and late replica code signals corresponding to the target code;
(c) correlating the subject signal with the early and late replica code signals and returning respective early and late correlation values; and
(d) calculating a code phase discriminator for determining whether the target code has been acquired as a function of the sum of the early and late correlation values.

2. A method according to claim 1 wherein the subject signal is received as a carrier wave signal modulated by the target code, the method further comprising the step of providing in phase (I) and quadrature phase (Q) components of subject signal; wherein, the I and Q components are each correlated with the early (E) and late (L) replica code signals to provide respective I_{E}, I_{L}, Q_{E} and Q_{L} correlation values; and wherein the code phase discriminator is calculated as a function of either I_{E}+I_{L} or Q_{E}+Q_{L}.

3. A method according to claim 2 wherein the code phase discriminator is calculated as a function of:
(I_{E}+I_{L})²30 (Q_{E}+Q_{L})²

4. A method according to claim 3 wherein the code phase discriminator is calculated as a function of:
Σ(I_{E}+I_{L})²+Σ(Q_{E}+Q_{L})²
wherein summation occurs over substantially the whole of the target code:

5. A method according to any preceding claim further comprising the steps of:
(e) applying a threshold test to the code phase discriminator to determine whether the target code has been acquired; and
(f) in the event that the target code has not been acquired, cyclically phase shifting the target code relative to the replica codes and recalculating the code phase discriminator until the target code is acquired.

6. A method according to claim 5 wherein the phase shift between the target code and the replica codes is two chips per cycle; and wherein the early and late replica signals are spaced one chip apart.

7. Apparatus comprising signal processing means (11 to 15) adapted to implement a method of code phase correlation according to any preceding claim.

8. A GPS receiver comprising receiver means for receiving a subject signal containing a target pseudorandom noise code; and processing means for generating early and late replica code signals corresponding to the target code, correlating the subject signal with the early and late replica code signals and returning respective early and late correlation values, and calculating a code phase discriminator for determining whether the target code has been acquired as a function of the sum of the early and late correlation values.

9. A GPS receiver according to claim 8 wherein in phase (I) and quadrature phase (Q) components of subject signal are provided wherein, the I and Q components are each correlated with the early (E) and late (L) replica code signals to provide respective I_{E}, I_{L}, Q_{E} and Q_{L} correlation values; and wherein the code phase discriminator is calculated as a function of either I_{E}+I_{L} or Q_{E}+Q_{L}.

10. A GPS receiver according to claim 8 or claim 9 wherein the code phase discriminator is calculated as a function of:
(I_{E}+I_{L})²+(Q_{E}+Q_{L})²

11. A GPS receiver according to claim 10 wherein the code phase discriminator is calculated as a function of:
Σ(I_{E}+I_{L})²+Σ(Q_{E+}Q_{L})²
wherein summation occurs over substantially the whole of the target code.

12. A GPS receiver as hereinbefore described with reference to the accompanying drawings.
